(19) United States
(12) Patent Application Publication
(10) Pub. No.: US 2025/0033706 A1
(43) Pub. Date: Jan. 30, 2025

(54) VEHICLE FRONT STRUCTURE

(71) Applicant: TOYOTA JIDOSHA KABUSHIKI KAISHA, Toyota-shi (JP)

(72) Inventors: Masahiro NOZAWA, Toyota-shi (JP); Hideyuki FUJIMAKI, Seto-shi (JP)

(73) Assignee: TOYOTA JIDOSHA KABUSHIKI KAISHA, Toyota-shi (JP)

(21) Appl. No.: 18/606,296

(22) Filed: Mar. 15, 2024

(30) Foreign Application Priority Data
Jul. 26, 2023 (JP) 2023-121382

(51) Int. Cl. B62D 25/08; B60R 19/24

(52) U.S. Cl. CPC B62D 25/08; B60R 2019/247

(57) ABSTRACT

The vehicle front structure is a part of a front fender panel, and includes a fender flange extending inward in the vehicle-width direction from an upper edge of a aesthetic surface of the front fender panel, a lamp unit disposed on the vehicle-downward side of the fender flange, and a bracket connecting the fender flange and the lamp unit. The bracket has a bent portion that extends in a direction toward one side in the vehicle-width direction toward the vehicle-upward side, and then turns back in a direction toward the opposite side in the vehicle-width direction toward the vehicle-upward side.

### CROSS-REFERENCE TO RELATED APPLICATION

This application claims priority to Japanese Patent Application No. 2023-121382 filed on Jul. 26, 2023, incorporated herein by reference in its entirety.

### BACKGROUND

### 1. Technical Field

The present specification discloses a front structure of a vehicle.

### 2. Description of Related Art

Some vehicles include a hood and front fender panels disposed on both right and left sides of the hood. Note that in general, a fender flange protrudes from an upper edge of an aesthetic surface of each of the front fender panels. When the hood is closed, these fender flanges are covered and hidden by the hood.

When such a vehicle collides with an obstruction outside of the vehicle, part of the obstruction (hereinafter referred to as “protection object”) may collide with an upper face of a vehicle front. Regulations of various countries stipulate that an area of a front of the vehicle where the protection object is predicted to collide has sufficient impact-absorbing properties. Examples of regulations of various countries include “Motor Vehicles: Safety Standards for Road Transportation Vehicles” mandated by the Ministry of Land, Infrastructure, Transport and Tourism of Japan, and so forth. Hereinafter, the area in which this collision is expected will be referred to as a “protection area”. In Japanese Unexamined Patent Application Publication No. 2014-91425 (JP 2014-91425 A), disposing substantially hat-shaped brackets between a radiator support and fender flanges is proposed, in order to enhance impact-absorbing properties at the vehicle front.

### SUMMARY

Conventionally, some sorts of components have been fastened to each of the fender flanges. Some of these components have poor impact-absorbing properties. For example, conventionally, a headlamp stay erected from an upper face of a lamp unit has been fastened directly to a fender flange. The lamp unit is a component in which a headlamp is incorporated. Such a lamp unit is not readily deformed, and cannot sufficiently absorb impact. When the lamp stay, which is a fastening portion between the lamp unit and the fender flange, is situated in the protection area, the protection object cannot be sufficiently protected in the event of a collision. Accordingly, conventionally, placement of the lamp unit has been adjusted such that the lamp stay is situated outside the protection area in plan view. However, in this case, degree of freedom in placement of the lamp unit, and consequently degree of freedom in design, are reduced.

Accordingly, disclosed in the present specification is a vehicle front structure that can further improve the degree of freedom of design.

A vehicle front structure disclosed in the present specification includes: a fender flange that is a part of a front fender panel and that protrudes toward an inward side in a vehicle-width direction from an upper edge of an aesthetic surface of the front fender panel;
an object component disposed on a vehicle-downward side of the fender flange; and
a bracket for connecting the fender flange and the object component.
   The bracket includes a bent portion that extends in a direction toward one side in the vehicle-width direction while extending toward a vehicle-upward side, and then turns back in a direction toward an opposite side in the vehicle-width direction while extending toward the vehicle-upward side.

The position of the object component is not constrained by the fender flange, due to the object component being connected to the fender flange via the bracket. Further, forming the bracket into a shape that is folded back in the vehicle-width direction enables impact, in the event of collision with the protection object, to be absorbed by deformation of the bracket. Accordingly, there is no problem with disposing the object component in the protection area. As a result, according to the above configuration, the object component can be freely disposed. Thus, the degree of freedom of the design can be improved.

In this case, a fastening portion of the object component that is fastened to the bracket may be situated inside a protection area that is stipulated in advance by regulations, as a range in which a collision of a protection object is anticipated, in plan view.

Conventionally, the fastening portion is disposed outside of the protection area, in order to protect the protection object. On the other hand, when the bracket that is folded back in the vehicle-width direction is employed, impact can be absorbed by this bracket. Accordingly, as described above, the fastening portion can be disposed inside the protection area.

Further, the object component may be a lamp unit in which a headlamp is incorporated,
the fastening portion may be a lamp stay that is erected from an upper face of the lamp unit, and
the bracket may extend in a direction toward an outward side in the vehicle-width direction from the lamp stay while extending toward the vehicle-upward side, and then turn back in a direction toward the inward side in the vehicle-width direction while extending toward the vehicle-upward side.

Such a configuration improves degree of freedom in placement of the headlamp. Thus, the degree of freedom of the design of the vehicle is further improved.

In this case, the bracket may include an upper flange that is provided at an upper end of the bracket, and that is elongated in a vehicle front-rear direction, the upper flange may be welded to the fender flange at a plurality of welding points arrayed at intervals in a front-rear direction, nearby a front end of the fender flange, in a state of being stacked with the fender flange in an up-down direction, and the bracket may be fastened to the lamp stay.

This configuration enables the bracket to also function as a reinforcing member that reinforces the vicinity of the front end of the fender flange. As a result, deformation in a vicinity of the front end of the fender flange, and consequently in a vicinity of a front end of the front fender panel, is suppressed.

Also, the lamp stay may be situated further on the inward side in the vehicle-width direction than the upper flange, and
a distance from the bent portion to a fastening site of fastening to the lamp stay in an up-down direction may be no less than twice a distance from the bent portion to the upper flange in the up-down direction.

This configuration enables a certain amount of space to be secured on the outward side of the lamp stay in the vehicle-width direction. Further, other components can be disposed in this space.

According to the vehicle front structure disclosed in the present specification, the degree of freedom of design can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a vehicle front;

FIG. 2 is a schematic plan view of a vehicle front;

FIG. 3 is a cross-sectional II-II view of FIG. 2;

FIG. 4 is a perspective view of the brackets; and

FIG. 5 is a cross-sectional view illustrating a state of deformation of a bracket when a protection object collides.

### DETAILED DESCRIPTION OF EMBODIMENTS

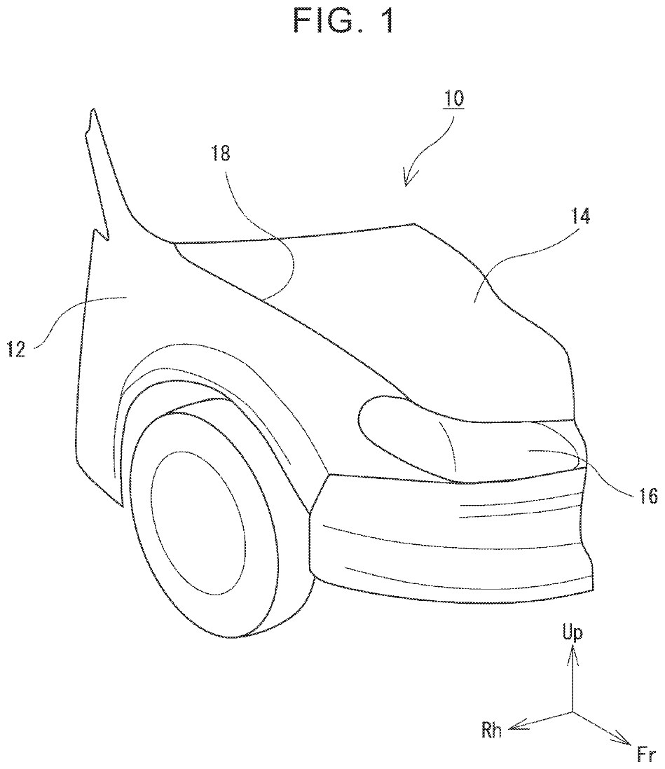

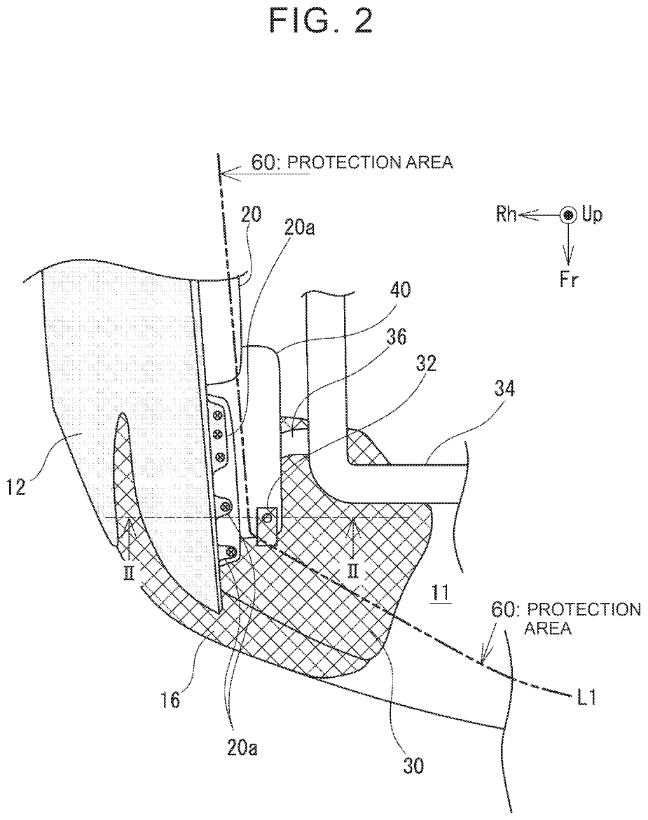

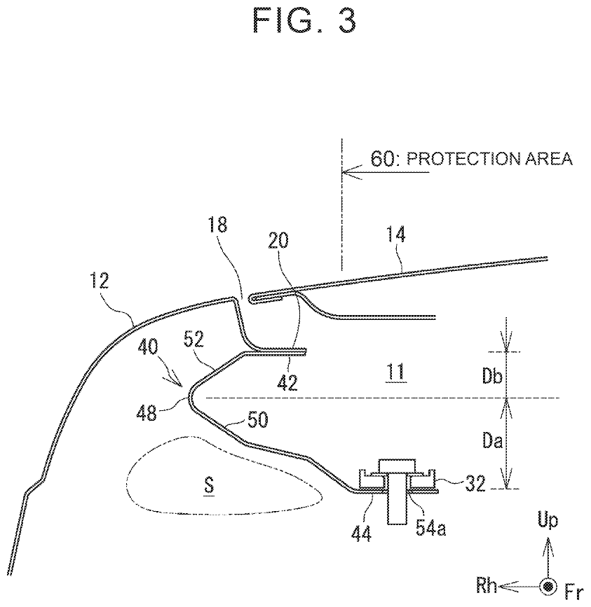

Hereinafter, a vehicle front structure will be described with reference to the drawings. FIG. 1 is a perspective view of a front portion of a vehicle 10. FIG. 2 is a schematic plan view of a front portion of the vehicle 10. FIG. 3 is a cross-sectional II-II view of FIG. 2. In the drawings, Fr, Up, and Rh indicate the front, upper, and right sides of the vehicle 10, respectively. In FIG. 2, the hood 14 is not illustrated. Further, in FIG. 2, the front fender panel 12 is gray hatched. The lamp unit 30 is crosshatched.

As illustrated in FIG. 1, a hood 14, a front fender panel 12, and a headlamp 16 are disposed at a front portion of the vehicle 10. The hood 14 is a panel member constituting the upper surface of the vehicle front portion. The hood 14 is opened and closed by swinging about a rotation axis set in the vicinity of the rear end. The lower side of the hood 14 is a power unit chamber 11 in which a power source, a heat exchanger (neither of which is shown), and the like are disposed.

A front fender panel 12 is disposed on both left and right sides of the hood 14. The front fender panel 12 is a panel member constituting a side surface of the vehicle front portion. An upper portion of the front fender panel 12 is curved inward in the vehicle-width direction. As a result, the upper end of the aesthetic surface of the front fender panel 12 is smoothly connected to the aesthetic surface of the hood 14. Hereinafter, the boundary between the aesthetic surface of the front fender panel 12 and the aesthetic surface of the hood 14 is referred to as a “parting line 18”.

The front fender panel 12 has a fender flange 20. As shown in FIGS. 2 and 3, the fender flange 20 is a portion protruding inward in the vehicle-width direction from the upper edge (i.e., the vicinity of the parting line 18) of the aesthetic surface of the front fender panel 12. The fender flange 20 is located below the aesthetic surface of the front fender panel 12. Therefore, when the hood 14 is closed, the fender flange 20 is covered and hidden by the hood 14. The vicinity of the front end of the parting line 18 is curved forward and downward. The fender flange 20 is divided into a plurality (three in the embodiment of FIG. 2) of small piece 20a near the front end so as to follow the curvature.

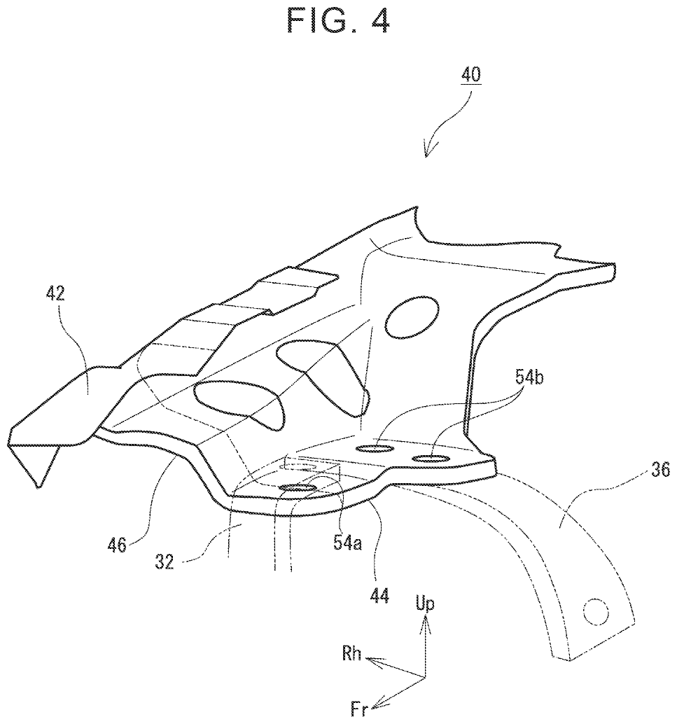

The headlamp 16 is disposed at the front end of the vehicle 10. The headlamp 16 is incorporated in the lamp unit 30. The lamp unit 30 is disposed inside the power unit chamber 11, that is, on the vehicle-downward side of the fender flange 20. A lamp stay 32 stands on the upper surface of the lamp unit 30. The lamp stay 32 is a portion for fastening the lamp unit 30 to another member. As shown in FIG. 4, the lamp stay 32 has a substantially L-shape that extends rearward of the vehicle after rising upward from the upper surface of the lamp unit 30. In the present example, the lamp stay 32 is fastened to a bracket 40 to be described later. The lamp unit 30 corresponds to a “object component” connected to the bracket 40. The lamp stay 32 corresponds to a “fastening portion” fastened to the bracket 40 of the lamp unit 30.

The bracket 40 is a member that connects the fender flange 20 and the lamp stay 32. With reference to FIGS. 3 and 4, the bracket 40 will be described. FIG. 4 is a perspective view of the bracket 40. As shown in FIGS. 3 and 4, the bracket 40 is roughly divided into an upper flange 42, a lower flange 44, and a connecting portion 46. The upper flange 42 is an upper end portion of the bracket 40. The upper flange 42 is welded to the fender flange 20 in a state of being superimposed on the lower side of the fender flange 20. The cross mark in FIG. 2 indicates a welding point between the upper flange 42 and the fender flange 20. As is apparent from FIG. 2, in the present example, the upper flange 42 is welded at a plurality of (five in the illustrated example) welding points arranged at intervals in the vehicle front-rear direction.

The lower flange 44 is a lower end portion of the bracket 40 and is a plate-like portion extending in the horizontal direction. The lamp stay 32 is fastened to the lower flange 44. A fastening hole 54a for fastening the lamp stay 32 is formed in the lower flange 44. The lower flange 44 is also coupled to the radiator support 34 (see FIG. 2) via a connecting plate 36 (see FIGS. 2 and 4). The radiator support 34 is a rigid member that supports a radiator (not shown) in the power unit chamber 11. A fastening hole 54b for fastening the connecting plate 36 is also formed in the lower flange 44.

The connecting portion 46 is a portion that connects the upper flange 42 and the lower flange 44. As shown in FIG. 3, the connecting portion 46 includes a lower inclined portion 50 extending from the lower flange 44 and an upper inclined portion 52 extending from the upper flange 42. The lower inclined portion 50 extends from the lower flange 44 in a direction toward the vehicle-upward side toward the vehicle-width direction outer side. Further, the upper inclined portion 52 extends from the upper flange 42 in a direction toward the vehicle-downward side toward the vehicle-width direction outer side. In other words, the connecting portion 46 has a bent portion 48 that extends to one side in the vehicle-width direction and then turns back to the opposite side in the vehicle-width direction. Further, as is apparent from FIG. 3, the vertical distance Da from the bent portion 48 to the fastening portion of the lamp stay 32 is two or more times the vertical distance Db from the bent portion 48 to the upper flange 42 (Da≥2×Db). Further, in the present example, the lower flange 44 is positioned inward of the upper flange 42 in the vehicle-width direction.

The reason why the bracket 40 having the above-described shape is provided will be described. Conventionally, the lamp stay 32 is often fastened directly to the fender flange 20 without using the bracket 40. In this case, the position of the lamp unit 30 is constrained to the position of the fender flange 20 and thus the parting line 18. As a result, the degree of freedom of the design of the vehicle 10 was low.

In addition, when the vehicle 10 collides with an obstruction outside the vehicle, a part of the obstruction (hereinafter referred to as a “protection object”) may collide with the upper surface of the front portion of the vehicle. At this time, in order to suppress the impact to be received by the protection object, standards are stipulated by laws and regulations of each country. Specifically, in the front portion of the vehicle 10, an area where a collision of a protection object is predicted (hereinafter, referred to as a “protection area 60”) is stipulated by laws and regulations so as to have sufficient shock absorbing property. The scope of the protection area 60 is stipulated by the laws and regulations of each country. For example, in the case of Japan, in Article 18 “Technical Standards for Pedestrian Head Protection” of “Motor Vehicle: Safety Standards for Road Transportation Vehicles” defined by the Ministry of Land, Infrastructure, Transport and Tourism, the standard of the protection area 60 is stipulated. Similar standards are also stipulated in the United Nations UN-R127/02.

When the lamp stay 32 is directly fastened to the fender flange 20, the lamp stay 32 needs to be disposed outside the protection area 60 in order to ensure sufficient shock absorbency. That is, when the lamp stay 32 is located in the protection area 60, a collision load is applied to the lamp unit 30 via the lamp stay 32. Since the lamp unit 30 is a rigid body that is not easily deformed, in this case, the lamp unit 30 cannot absorb an impact, and a reaction force from the lamp unit 30 acts on the protection object. As a result, the protection object is subjected to a large impact. In order to avoid such a problem, the position of the headlamp 16 and the parting line 18 are conventionally adjusted so that the lamp stay 32 is located outside the protection area 60. In other words, when the lamp stay 32 is directly fastened to the fender flange 20, the degree of freedom of the design of the vehicle 10 is greatly reduced in order to ensure the shock absorbing property.

On the other hand, in the present example, as described above, the bracket 40 is interposed between the lamp stay 32 and the fender flange 20. Accordingly, the position of the lamp stay 32 and thus the lamp unit 30 can be freely set to some extent.

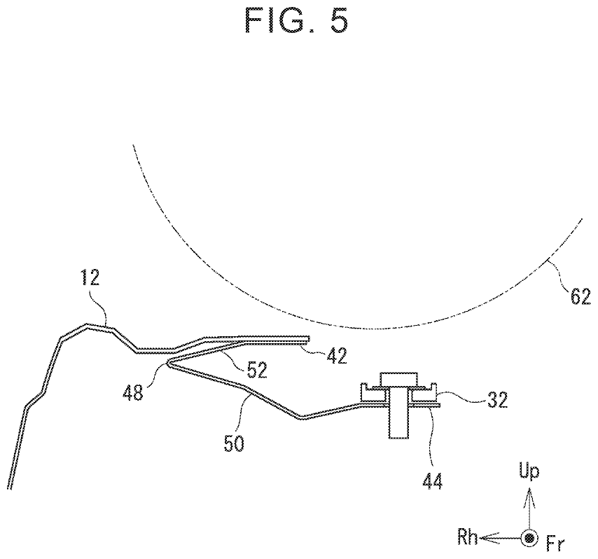

The bracket 40 has a bent portion 48 that is folded back in the vehicle-width direction. With such a configuration, when a downward collision load is applied to the bracket 40 at the time of the front collision, the bracket 40 is easily folded at the bent portion 48 as shown in FIG. 5. The shock is absorbed by the deformation of the bracket 40. Then, the reaction force acting on the protection object can be reduced.

Further, in the present example, since the bracket 40 is employed, the lamp unit 30 can be easily separated from the hood 14. As a result, even if the protection object collides with the upper side of the hood 14, the protection object does not hit the lamp unit 30. Accordingly, a reaction force is not applied from the lamp unit 30 to the protection object, and an impact applied to the protection object can be reduced. In accordance with the above-described laws and regulations, it is possible to predict the collision stroke of the protection object at the time of the front collision, and thus the maximum advancing position of the protection object. In the present example, the lamp stay 32 is disposed below the maximum advance position of the protection object. Note that a two-dot chain line in FIG. 5 indicates a substantially spherical protection object 62 that has advanced to the maximum advance position.

As described above, by adopting the bracket 40 that is folded back in the vehicle-width direction, it is possible to increase the degree of freedom in the arrangement of the lamp unit 30 while reducing the impact applied to the protection object. In FIG. 2, a line L1 indicated by a two-dot chain line is a line indicating a border of the protection area 60. The inner side of the line L1 is a protection area 60. In the present example, the lamp stay 32, that is, the fastening portion between the lamp unit 30 and the bracket 40 is positioned inside the protection area 60 in a plan view.

Incidentally, as described above, the upper flange 42 of the bracket 40 is long in the vehicle front-rear direction. The upper flange 42 of the bracket 40 is welded to the fender flange 20 at a plurality of welding points arranged at intervals in the vehicle front-rear direction. With this configuration, the bracket 40 also functions as a reinforcing member that reinforces the periphery of the front end of the fender flange 20. That is, the periphery of the front end of the fender flange 20 is divided into a plurality of small piece 20a, and is easily deformed. The fender flange 20 is connected to the radiator support 34 via the bracket 40 in order to suppress deformation around the front end of the fender flange 20 and thus around the front end of the front fender panel 12. At this time, the fastening portion between the fender flange 20 and the bracket 40, that is, the upper flange 42 has a certain length in the vehicle front-rear direction. Therefore, the periphery of the front end of the fender flange 20 can be reinforced more stably.

Further, as shown in FIG. 3, the vertical distance Da from the bent portion 48 to the lamp stay 32 is set at least twice the vertical distance Db from the bent portion 48 to the upper flange 42. Accordingly, a larger space S can be secured on the vehicle-width direction outer side of the lower inclined portion 50. Various components can be arranged in the space S.

In addition, any of the configurations described above is an example, and may be changed as appropriate as long as the configuration described in claim 1 is provided. For example, the bent portion 48 of the bracket 40 described above is convex outward in the vehicle-width direction. However, the bent portion 48 of the bracket 40 may be convex inward in the vehicle-width direction in accordance with the arrangement state of the peripheral component. In addition, the above-described bracket 40 has only one bent portion 48. However, the bracket 40 described above may have a greater number of bent portions 48. That is, the bracket 40 may have an accordion shape in which a plurality of diffraction returns in the vehicle-width direction. In the above description, the bracket 40 is fastened to the lamp unit 30. However, the bracket 40 may be disposed on the vehicle-downward side of the fender flange 20, and may be fastened to other components as long as the components are to be connected to the fender flange 20.

What is claimed is:

1. A vehicle front structure, comprising:
a fender flange that is a part of a front fender panel and that protrudes toward an inward side in a vehicle-width direction from an upper edge of an aesthetic surface of the front fender panel;
an object component disposed on a vehicle-downward side of the fender flange; and
a bracket for connecting the fender flange and the object component, wherein
the bracket includes a bent portion that extends in a direction toward one side in the vehicle-width direction while extending toward a vehicle-upward side, and then turns back in a direction toward an opposite side in the vehicle-width direction while extending toward the vehicle-upward side.

2. The vehicle front structure according to claim 1, wherein a fastening portion of the object component that is fastened to the bracket is situated inside a protection area that is stipulated in advance by regulations, as a range in which a collision of a protection object is anticipated, in plan view.

3. The vehicle front structure according to claim 2, wherein:
the object component is a lamp unit in which a headlamp is incorporated;
the fastening portion is a lamp stay that is erected from an upper face of the lamp unit; and
the bracket extends in a direction toward an outward side in the vehicle-width direction from the lamp stay while extending toward the vehicle-upward side, and then turns back in a direction toward the inward side in the vehicle-width direction while extending toward the vehicle-upward side.

4. The vehicle front structure according to claim 3, wherein:
the bracket includes an upper flange that is provided at an upper end of the bracket, and that is elongated in a vehicle front-rear direction;
the upper flange is welded to the fender flange at a plurality of welding points arrayed at intervals in a front-rear direction, nearby a front end of the fender flange, in a state of being stacked with the fender flange in an up-down direction; and
the bracket is fastened to the lamp stay.

5. The vehicle front structure according to claim 4, wherein:
the lamp stay is situated further on the inward side in the vehicle-width direction than the upper flange; and
a distance from the bent portion to a fastening site of fastening to the lamp stay in an up-down direction is no less than twice a distance from the bent portion to the upper flange in the up-down direction.
